(19) United States
(12) Patent Application Publication
(10) Pub. No.: US 2004/0027658 A1
(43) Pub. Date: Feb. 12, 2004

(54) Illuminated microscope system

(76) Inventor: Michael Q. Fu, Monroe Township, NJ (US)

Correspondence Address: J. Gary Mohr, 3 Lisa Lane, Goshen, NY, 10924, US

(21) Appl. No.: 10/400,839

(22) Filed: Mar. 27, 2003

Related U.S. Application Data
(60) Provisional application No. 60/368,012, filed on Mar. 27, 2002.

(51) Int. Cl. G02B 23/00

(52) U.S. Cl. 359/425

(57) ABSTRACT

A battery, low voltage, illuminated microscope comprising a housing consisting of top microscope head and bottom base, having mounted therein an optical system having a direct light pathway comprising a single lens eyepiece, an intermediate focus wheel and an adjustable double lens objective, a slide holder forward of said objective, a slot in the housing covers by which a slide is introduced into the slide holder and an LED light means under said slide holder by which light from the LED light source passes through the slide to be viewed. An LED light source mounting contained in the base below the collecting lens and on the optical axial. The batters, usually AA, are contained in the microscope base and are accessible by the microscope operator for replacement. The illuminated microscope has means to regulate the light intensity of the source and means to actuate the light source.

### RELATED APPLICATIONS

This application herein incorporates by reference and claims priority to provisional application No. 60/368,012 filed on Mar. 27, 2002.

### BACKGROUND OF THE INVENTION

This invention comprises a portable battery operated compact microscope for use in examining slides quickly and efficiently.

Microscopes are instruments that are used to observe the micro field that human eyes are unable to identify. Microscopes require illumination, either natural or artificial, to illuminate the specimen and the optical system. Artificial illumination is usually provided by electrical bulbs, which include incandescent bulbs, halogen-tungsten bulbs and fluorescent bulbs. All those illumination systems require high voltage power supplies (110 v in the USA and 20-240V in Europe).

Presently there is a need in the practice of medicine to have available portable or self contained illuminated microscopes to provide a better and faster means of diagnosing and treating patients. Often during the examination of a patient, a doctor must send samples to a location removed from the patient, since the standard illuminated microscopes require line cords and lighting system that consume high voltage that would not be conducive to battery operation and therefore not conducive to having close to the patient during procedures. Therefore, faster diagnosis, by having a battery illuminated, self contained battery small microscope available would considerably upgrade patient care and treatment.

Such problems are particularly marked and prevalent in the diagnosis and treatment of infections.

In a conventional laboratory setting, after a swabbed or scraped sample has been taken to diagnose for and infections, the specimen must be rushed to a lab away from the patient and much time taken to prepare a slide after which the diagnosis is made. During this time-consuming process the patient often must lie on the table in the examination room.

To upgrade patient comfort and care, it would be of utmost benefit to arrive at a rapid but accurate means of diagnosing such infections in the examination room. For such diagnosis, a compact portable battery illuminated microscope would be desirable.

U.S. Pat. No. 3,582,181 issued Jun. 1, 1971 teaches a portable pocket microscope having its own light source so as to be available for usage in a variety of locations. This microscope is in two sections which must be press fitted together in a telescopic relationship. A two lens eyepiece is mounted in one tubular section and a two-lens objective, light source and object slide slot are located in the second tubular section. The fitting together of the two tubular sections under pressure produces a telescope arrangement which is elongated and, therefore, not truly compact in nature. This prior art microscope provides a light source which is constant whereas an adjustable light source is to be preferred.

### SUMMARY OF THE INVENTION

It is an object of the present invention to provide a portable compact microscope for use in a medical examination room setting.

It is also an object of the present invention to provide a compact microscope wherein a self-contained light source is adjustable in intensity so as to penetrate slides.

Further objects of the present invention are to provide a microscope that may be used if no power is available, or the power is not sufficient, the microscope is useable outdoors, and to promote safety by having low voltage.

These and other objects may be accomplished by means of a compact microscope having a generally rectangular housing containing, in series, an eyepiece with a single lens, a two-lens objective mounted so as to be adjustable, a slide holder into which the slide is introduced by a receiving slot in the housing and a mounted LED light source to direct light through the object slide into the objective and through the eyepiece to the observer. The housing also contains a low voltage LED light mounting source, an adjustment wheel which regulates the light intensity by a connection to a potentiometer and batteries. The elements of the lighting system are in alignment with the direct observation path. Also connected into the lighting system is an on-off switch. In order to more efficiently replace the batteries and the LED light source, the microscope housing is provided with an access panel.

The preferred embodiment will hereinafter be described in detail.

### DRAWINGS

FIG. 1 is a simplified electric schematic of the microscope of the invention

FIG. 2 is a side view of the microscope of the invention.

### DETAILED DESCRIPTION

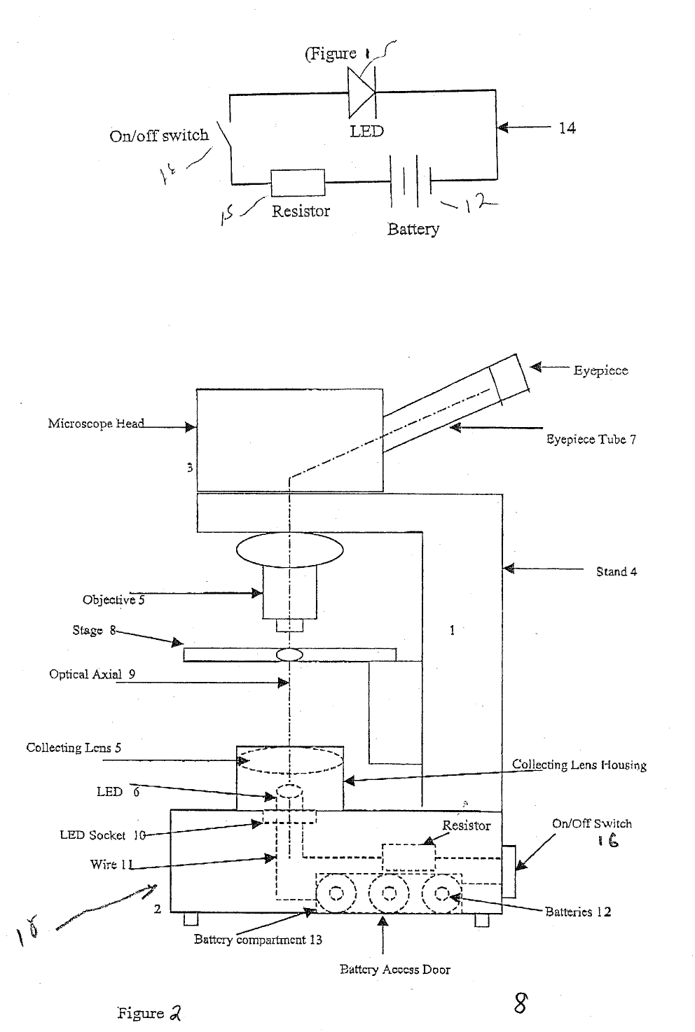

There is shown in FIGS. 1 & 2 an embodiment of the invention.

The microscope 1 is contained in a housing which may be of molded plastic and is divided horizontally into a lower or base section 2 and an upper section 3. The two sections are fastened together by mounting arm 4.

FIG. 2 shows the optics 5 and lighting system 6 of the microscope. An adjustable eyepiece assembly 7 containing either a single or multiple lens system, not shown, but known in the art.

The microscope 1 has a stage 8 for mounting a specimen slide in a retaining means, not shown, but known in the art.

The viewing path or optical axis of the microscope 1 is shown in a doted line. The path 8 may or may not require prisms, not shown, but known in the art, depending on the location of eyepiece 7. The magnification of the double or multiple lenses in the objective and eyepiece may vary according to usage desired.

The remainder of the elements within microscope 1 are a light emitting diode (LED) lighting system 6, which may or may not be adjustable such as through the use of a potentiometer, that contains an LED socket mount 10 located directly in the optical path 9 in which the LED light source 6 is mounted and connected by an electrical transmitting source, such as wire 11 to a battery source 12 for providing current to LED light source 6. The Led light 26 is powered by one or more battery 12 enclosed in battery holder, not shown, but known in the art, within battery compartment 13. An optional AC adapter, as know in the art, could be used in substitute of the battery if one wished. The positive terminal of the battery is electrically connected to a potentiometer, not shown, but known in the art. The potentiometer is electrically connected to an on/off switch, not shown, but known in the art. The on/off switch 16 is electrically connected to one section of circuit 14 of FIG. 1 or a split printed circuit board, not shown, but known in the art with the negative terminal of battery 12 connected to the other section of the printed circuit board in order to activate the LED light source 6 of microscope 1. A portion of housing base 2 has a removable or swing-out access panel, not shown, but known in the art, to provide operator access into the housing compartment for replacing spent batteries 12 or LED 6. An optional potentiometer operated by a light adjustment wheel, not shown, but known in the art, controls the flow of electricity to LED 6 by altering the resistance and hence controls the light intensity of the LED 6 to observe a slide placed on stage 8 of the microscope 1.

The electrical components are conventional “off the shelf” items and no claim is made to these components individually. The precise manner in which the electrical components are secured in the housing is not critical provided the compact nature of the housing and the direct viewing path of the optical system with the LED lighting is maintained. Turning now, however, to the electric circuit, FIG. 1, it contains the LED 6, a resistor 15, an on-off switch 16 and the battery source 12. The LED 6 is driven by the DC current from the battery 12.

The resistor 15 regulates or controls the current from the battery 12 to the LED 6 and prevents current surge, which may damage the LED 6 or shorten the lifetime of the LED 6. The operation of the microscope 1 is essentially the same as with other microscopes except that the optical path is shorter than with most microscopes. Because of the short viewing path, a condenser is not needed to concentrate the light. It is this proper positioning of the LED 6 in the microscope base 18, as shown in FIG. 2, right below the collecting lens 5, and on the optical axial 9, that makes the illumination of LED 6 sufficient to operate the microscope 1. While another battery 12 combination may be used, three 1.5V AA size batteries, with a 4.5V output works quite well in the present invention.

Microscope 1 is compact and may be used in any variety of situations other than an examination room setting.

While the microscope 1 as has been disclosed constitutes a preferred embodiment, changes or modifications in shape or structure may be made without departing from the scope of this invention which is to be limited only by the appended claims.

I claim:

1. A compact portable lighted microscope for viewing of slides comprising;
a) a generally rectangular housing divided into a lower base section and an upper section, said sections being interconnectable by fastening means, and
b) a LED lighting source that is battery activated.

2. A microscope according to claim 1 wherein the intensity of the light from said LED light source is regulated by a potentiometer.

3. A microscope according to claim 1 containing an on-off LED switch.

4. A microscope according to claim 1 having removable access panel in said housing to provide access to said light source and battery means.

5. A battery operated illuminated microscope comprising an electrical circuit with an LED source, a resistor, a battery source and a source to connect and disconnect the battery source to the LED source.
